(19) United States
(12) Patent Application Publication
(10) Pub. No.: US 2015/0148514 A1
(43) Pub. Date: May 28, 2015

(54) METHOD FOR IDENTIFYING BIOABSORBABLE POLYMERS

(71) Applicant: Lubrizol Advanced Materials, Inc., Cleveland, OH (US)

(72) Inventors: Umit G. Makal, Stow, OH (US); Roger W. Day, Solon, OH (US)

(21) Appl. No.: 14/407,660

(22) PCT Filed: Jun. 24, 2013
(86) PCT No.: PCT/US13/47221

§ 371 Date: Dec. 12, 2014

Related U.S. Application Data
(60) Provisional application No. 61/663,654, filed on Jun. 25, 2012.

(51) Int. Cl. G06F 19/00; C08G 18/32; C08G 18/72

(52) U.S. Cl. CPC G06F 19/704; C08G 18/72; C08G 18/3203
USPC 528/85; 703/12

(57) ABSTRACT

A system and method for producing a bioabsorbable thermoplastic polyurethane tailored to a medical application are provided. The method includes identifying suitable thermoplastic polyurethane properties based on the medical application. The thermoplastic polyurethane comprises units derived from a diol chain extender, a diisocyanate, and a polyol. The thermoplastic polyurethane properties include a biodegradation rate and at least one physical property. The method includes identifying a base thermoplastic polyurethane and altering at least one parameter of the base thermoplastic polyurethane which relates to the desired thermoplastic polyurethane properties to generate a candidate thermoplastic polyurethane. The altering may be performed iteratively until the suitable range of thermoplastic polyurethane properties based on the medical application is met.

### FIELD OF INVENTION

The present embodiment relates to bioabsorbable polymers and finds particular application in connection with a system and method for identifying such compounds.

### BACKGROUND

There has been an increasing interest in the use of biodegradable or bioabsorbable materials, rather than biostable biomaterials, in a number of applications in the biomedical field. The increasing biosafety and long-term stability issues with many implants are major driving forces for this trend. The innovations in biomedical processes, such as tissue engineering, gene therapy, controlled drug release, and regenerative medicine have accelerated the use of biodegradable materials to make devices which help the body to repair and regenerate the damaged tissue so that many post or ex-plantation operations are avoided. Exemplary of the biomedical applications of biodegradable materials are implants, such as screws, pins, bone plates, staples, sutures (monofilament and multifilament), drug-delivery vehicles, membranes for guided tissue regeneration, mesh and porous materials for tissue engineering, antiadhesion barriers, tissue scaffolds, cardiovascular grafts, and wound dressings.

One of the key limitations of these materials for many of the potential applications has been the lack of the proper combination of physical properties such as tensile strength, flexibility, elongation, abrasion resistance, etc., for the application. Many of these materials are brittle and are not sufficiently strong for the intended application and there has been significant research toward improving the physical and mechanical properties of these materials through various means, including varying and modifying the chemical structure and blending of these polymers with other polymers to increase their strength, flexibility, and the like.

In addition to the desire for good physical and mechanical properties in these applications, there is a need to be able to moderate or accelerate the biodegradation rate of the materials to precisely meet the need for the application. For instance, for a wound dressing application, a biodegradation rate of days might be appropriate, while for an orthopedic application, degradation rates of months or even years in some cases might be more appropriate. Even in a given application, the rate of biodegradation that would be optimally desired might be different, depending on the individual patient. For instance, an older patient or one in poor health might benefit from a material that would degrade more slowly to match their individual rate of healing. Currently, such precise matching of the degradation rates and physical and mechanical properties of the biosorbable polymers to the specific requirements of the application or even to the needs of the individual patient has not been possible using the biosorbable polymers that are available even though it is widely known that such an ability would have significant therapeutic benefit. Accordingly, there has been much study on the ways to modify polymer structure to affect the rate of bioabsorption.

Currently available biomaterials have rather narrow ranges of combinations of these parameters and therefore, the medical industry often must choose the closest approximation to what they need from the materials that are commercially available. There have been numerous technical efforts to increase the range of properties and degradation rates of bioabsorbable polymers. See, for example, M. Florczak, J. Libiszowski, J. Mosnacek, A. Duda, S. Penczek, Macromol. Rapid Coomun., 28, 1385 (2007); I. Rashkov, N. Manolova, S. M. Li, J. L. Espartero, M. Vert, Macromolecules, 29, 50 (1996); K. Garkhal, S. Verma, S. Jonnalagadda, N. Kumar, J. Polym. Sci. Part A, Polymm. Chem., 45, 2755 (2007); E. Grigat, R. Koch, R. Timmermann, Polym. Degrad. Stab., 59, 223 (1998); and I. Vroman, L. Tighzert, Materials, 2, 307 (2009). These efforts usually involve blending of existing bioabsorbable polymers to achieve intermediate properties and/or degradation rates or preparing copolymers of the monomeric building blocks that are currently used in the bioabsorbable polymers which are in commercial use today.

There remains a need for a method for tailoring a class of bioabsorbable polymers to meet a variety of applications.

### BRIEF DESCRIPTION

In accordance with one aspect of the exemplary embodiment, a system for proposing a bioabsorbable thermoplastic polyurethane compound tailored to a medical application. The system includes memory which stores a data structure and instructions. The instructions include instructions for (i) receiving a user input specifying at least one desired physical property of a thermoplastic polyurethane compound and a desired biodegradation property for the thermoplastic polyurethane compound; (ii) accessing the data structure to identify at least one base thermoplastic polyurethane compound with a measured physical property and measured degradation property that are similar to the desired physical property and desired biodegradation property; (iii) providing for identifying at least one of: (a) at least one first parameter which is modifiable to reduce a difference between the desired physical property and the measured physical property, and (b) at least one second parameter which is modifiable to reduce a difference between the desired biodegradation property and the measured biodegradation property; (iv) identifying at least one candidate thermoplastic polyurethane compound based on computed modifications to at least one of (a) at least one of the at least one first parameter, and (b) at least one of the at least one second parameter; and (v) outputting a formulation for at least one of the candidate thermoplastic polyurethane compounds. The method may further include (vi) receiving a measured physical property and a measured degradation rate of a formulated one of the at least one of the candidate thermoplastic polyurethane compounds and repeating (iii), (iv), (v) and (vi), wherein the formulated polyurethane compound serves as the base thermoplastic polyurethane compound. A processor in communication with the memory implements the instructions.

In accordance with another aspect of the exemplary embodiment, a method for producing a bioabsorbable thermoplastic polyurethane compound tailored to a medical application includes specifying a desired thermoplastic polyurethane compound by at least one desired physical property of a thermoplastic polyurethane compound and a desired biodegradation property for the thermoplastic polyurethane compound. With a computer processor, a data structure is queried, based on the specified thermoplastic polyurethane compound to identify a base thermoplastic polyurethane compound. The desired physical property of the thermoplastic polyurethane compound and the desired biodegradation property of the thermoplastic polyurethane compound are compared with a physical property and a biodegradation property of the base thermoplastic polyurethane compound. The method further includes identifying at least one of at least one first parameter which is modifiable to reduce a difference between the desired physical property and the measured physical property, and at least one second parameter which is modifiable to reduce a difference between the desired biodegradation rate and the measured biodegradation rate. The method further includes identifying at least one candidate thermoplastic polyurethane compound based on computed modifications to at least one of the identified first parameter and the identified second parameter and outputting a formulation for at least one of the candidate thermoplastic polyurethane compounds.

In accordance with another aspect of the exemplary embodiment, a method for producing a bioabsorbable thermoplastic polyurethane tailored to a medical application includes identifying suitable thermoplastic polyurethane properties based on the medical application. The thermoplastic polyurethane comprises units derived from a diol chain extender, a diisocyanate, and a polyol and the thermoplastic polyurethane properties include a biodegradation rate and at least one physical property. The method includes identifying a base thermoplastic polyurethane, and altering at least one parameter of the base thermoplastic polyurethane which relates to the desired thermoplastic polyurethane properties to generate a candidate thermoplastic polyurethane, the altering being performed iteratively until the suitable range of thermoplastic polyurethane properties based on the medical application is met.

In accordance with another aspect of the exemplary embodiment, a formulated set of bioabsorbable thermoplastic polyurethane polymers whose degradation rate and mechanical properties are independently varied over a range are each derived from a low molecular weight diol chain extender, a diisocyanate, and a polyol which contains bioabsorbable units in its backbone.

In accordance with another aspect of the exemplary embodiment, a method for identifying a thermoplastic polyurethane includes defining physical and degradation properties of a class of thermoplastic polyurethanes as a function of a set of parameters selected from the group consisting of molecular weight (Mw), hard segment content (HS %), polyol chemical identity, and the degree of phase separation (PS) of the thermoplastic polyurethane; MW of polyol; contact angle/water absorption (hydrophilicity); and concentration of bioabsorbable units in backbone, adjusting the parameters to achieve a candidate thermoplastic polyurethane which is expected to have desired physical and degradation properties, comparing physical and degradation properties of the candidate thermoplastic polyurethane when formulated with the desired physical and degradation properties, readjusting the parameters, based on the comparison, to achieve another candidate thermoplastic polyurethane which is expected to have desired physical and degradation properties.

### BRIEF DESCRIPTION OF THE DRAWINGS

FIG. 1 illustrates a system for identifying bioabsorbable polymers in accordance with one aspect of the exemplary embodiment;

FIG. 2 illustrates a method for identifying bioabsorbable polymers in accordance with another aspect of the exemplary embodiment;

FIG. 3 shows degradation of tensile strength of TPUs with 30% hard segment content (% HS) and different poly lactic acid contents (% PLA) in the soft segment in the range of 0-50%;

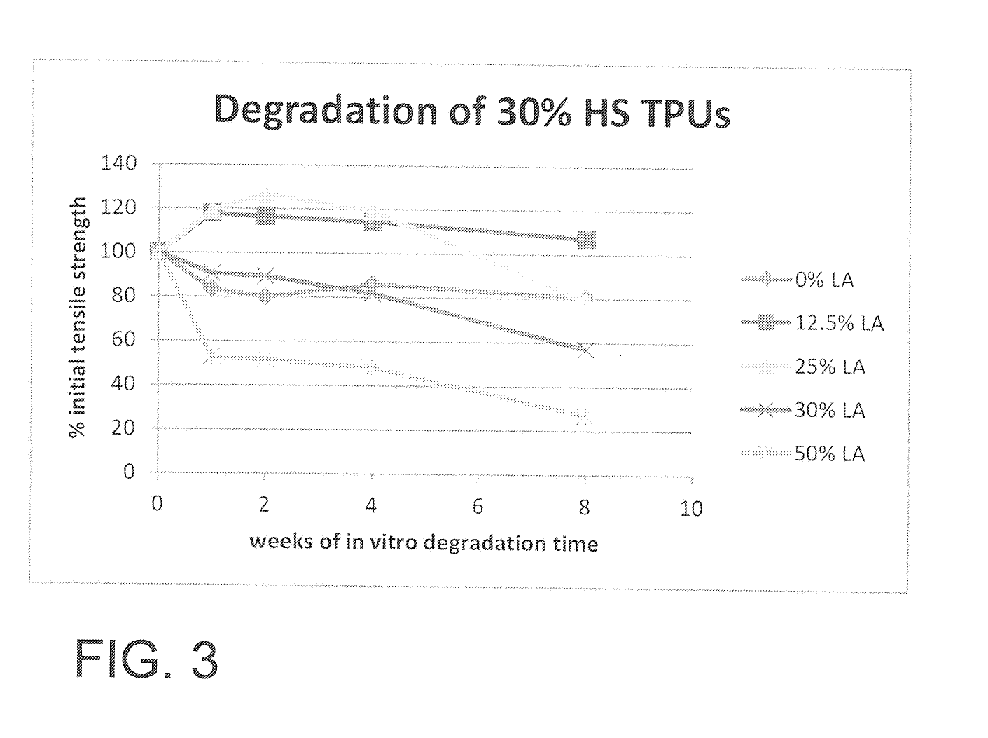

FIG. 4 shows degradation of M_{w} of the TPUs of FIG. 3;

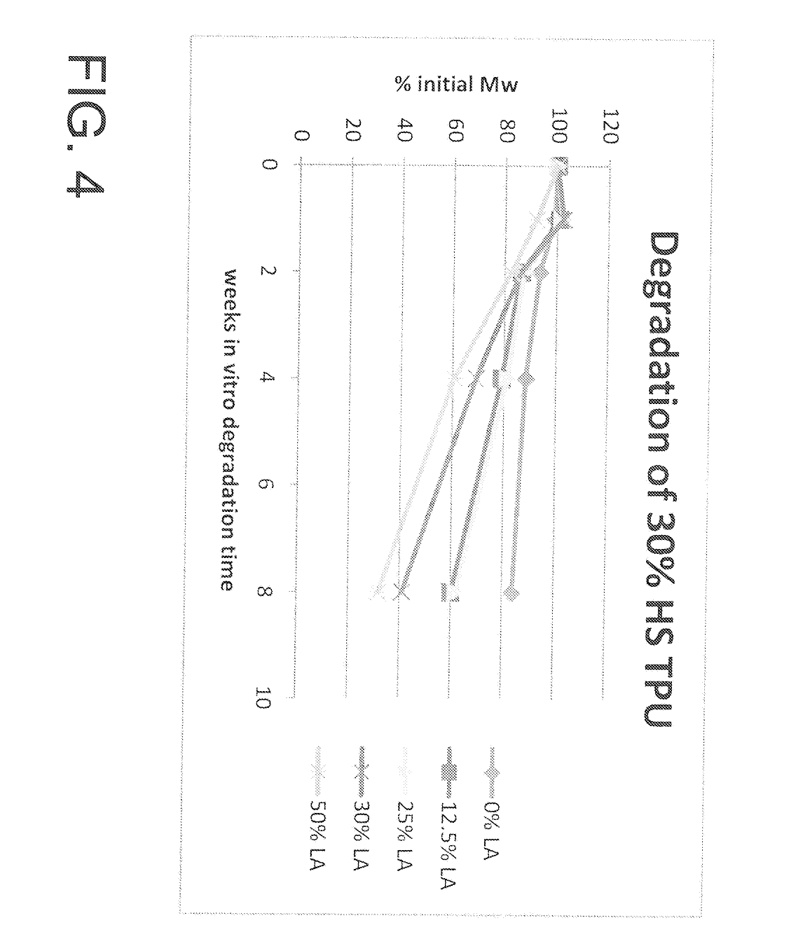

FIG. 5 shows degradation of tensile strength of TPUs made with polyol with 50% poly lactic acid content and different percentages of hard segment in the TPU;

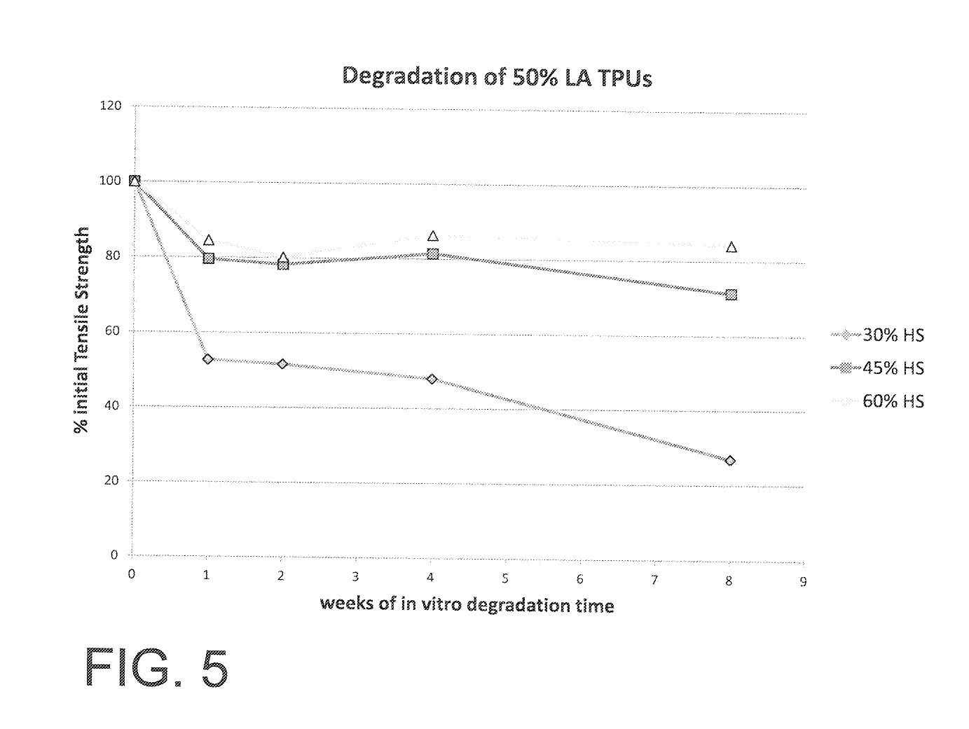

FIG. 6 shows degradation of tensile strength of TPUs formed with 30% PLA, 60% HS and 50% PLA, 65% HS, respectively, showing that similar biodegradation rates can be achieved with different initial tensile strength values; and

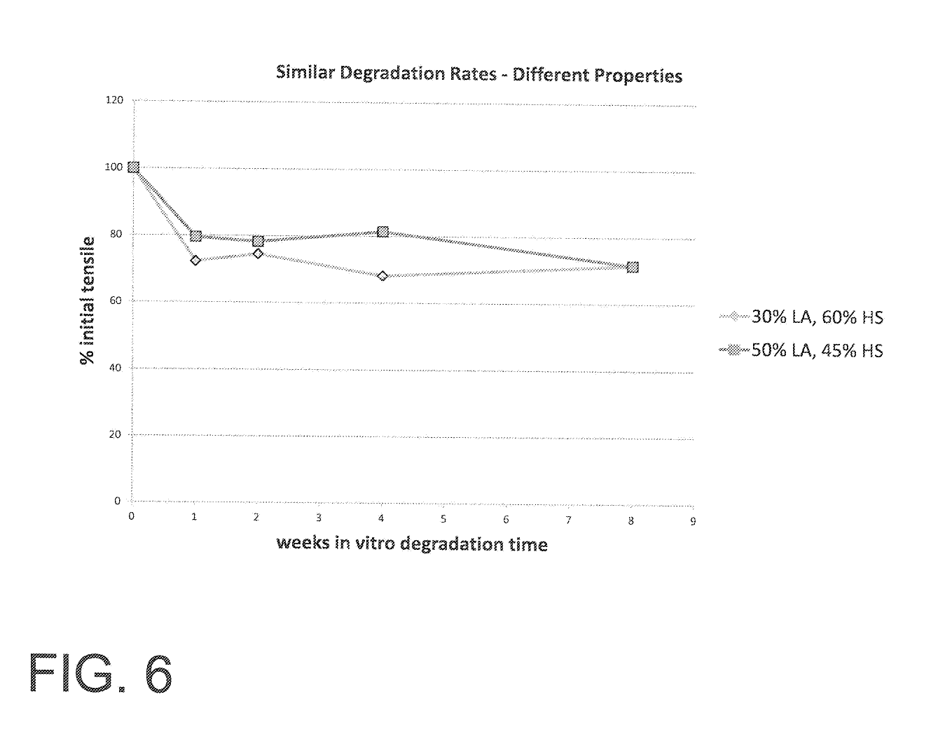

FIG. 7 shows degradation of tensile strength of TPUs formed with 25% PLA, 45% HS and 50% PLA, 30% HS, respectively, showing that different biodegradation rates can be achieved with the same initial tensile strength values.

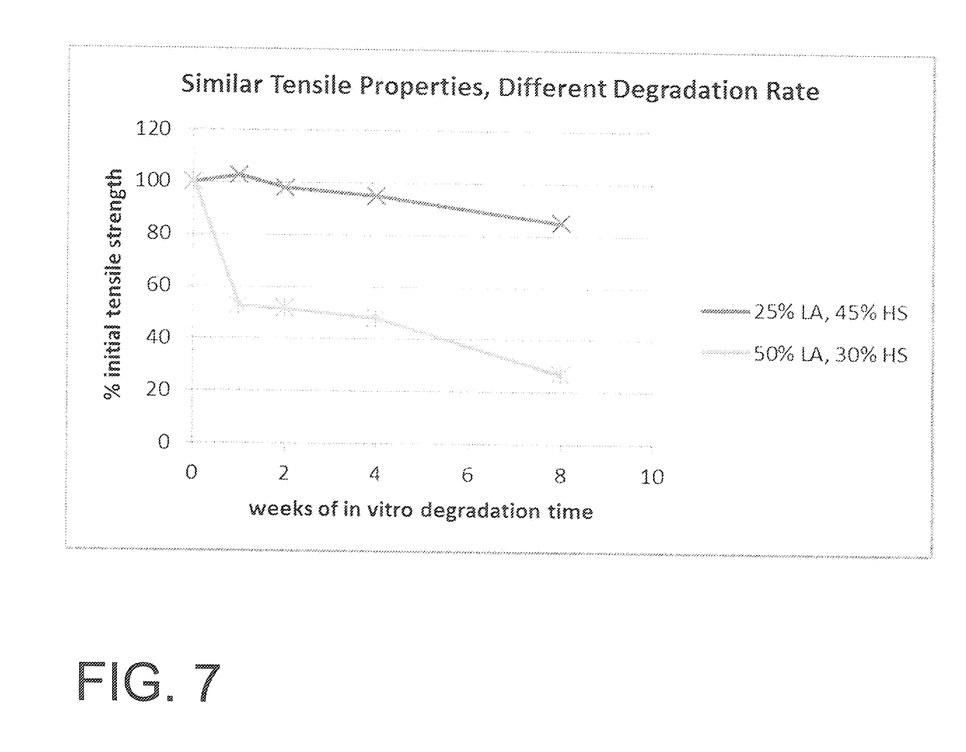

While some similar TPU materials which contain similar structures and which are claimed to be biosorbable have been reported in the literature, there are nowhere in the literature reported materials of this type wherein the degradation rate and the physical properties can be independently and continuously adjusted to specifically match the requirements of the medical application or even the requirements of the individual patient. This capability, although widely recognized by the medical community as highly desirable for their therapeutic usefulness has never before been reported. Our disclosure of a process for producing such a highly useful and novel new class of materials which contains and essentially infinite number of materials differing in properties and degradation rates and which fill in the gaps where materials which have previously been describe are not currently available is, therefore, surprising and of high value in the biomedical device industry.

### DETAILED DESCRIPTION

Aspects of the exemplary embodiment relate to a system and method for selection of bioabsorbable polymers and to a database comprising properties of a set of bioabsorbable polymers, the properties including biodegradation properties of the bioabsorbable polymers.

The exemplary system and method allow both the physical and mechanical properties and the biodegradation rates of polymers to be independently modified to precisely match the needs of the application or to fit a particular patient profile.

The exemplary set of bioabsorbable polymers, through minor variations of ratios of ingredients allow significant differences in bioabsorption rate and physical properties to be achieved independently of one another.

As used herein, a bioabsorbable polymer is a polymer which when placed into the body of a human or animal subject is absorbed by the body, for example, by hydrolyzation and/or enzymatic cleavage. The biosaborption properties of the polymer are simulated through measurable biodegradation properties. A bioabsorbable polymer thus has one or more biodegradation properties, such as a change in molecular weight with time, a change in tensile strength with time, a change in weight of the polymer with time, or a combination thereof. The biodegradation property is computable, for example, through in vitro measurements in conditions which simulate the conditions to which the bioabsorbable polymer is expected to be exposed in the body. The measured change in the biodegradation property, under such test conditions is generally no less than 10% over the course of a year. However, a wide variation in the biodegradation properties of the exemplary polymers is provided in order to enable candidate polymers to be identified which cover a range of the biodegradation property.

The exemplary bioabsorbable polymers include bioabsorbable thermoplastic polyurethane compounds. A thermoplastic polyurethane is a polyurethane which includes hard segments and soft segments. The hard segments are generally derived from an isocyanate and a chain extender. The soft segments are derived from a polyol. The term “polyurethane” as used herein includes polyureas and compounds with both urethane and urea linkages.

The soft segment provides some or all of the biodegradation properties of the polymer, although in some embodiments, at least some of the degradation properties are influenced by the chain extender.

The thermoplastic polyurethane compound (TPU) can thus be a multiblock copolymer which is the reaction product of a) at least one polyol, b) at least one chain extender, c) at least one isocyanate, and d) optionally at least one catalyst, and e) optionally at least one additive, other than the components a), b), c) and d).

Component (a) provides the soft segment of the final TPU material. Suitable polyols include OH-terminated oligomeric glycols, such as polyether polyols, polyester polyols, and mixtures and derivatives thereof. Exemplary polyether polyols include polyethylene glycol (PEG), and poly(trimethylene oxide)glycol (PTMEG). Exemplary polyester polyols include aliphatic polyester polyols, such as copolymers of a cyclic lactone (such as lactide, glycolide, acetolactone, beta-propiolactone, caprolactone, valerolactone, butyrolactone, pivalolactone, or decalactone) and an α-hydroxy acid or ester thereof (such as lactic acid or glycolic acid), and polymer blends thereof. Examples of such polyester polyols include poly(lactide-co-caprolactone (CAPA), and poly(glycolide-co-caprolactone). Other exemplary polyester polyols include polylactic acid, polyalkylene adipates (such as poly(butylene adipate), poly(ethylene adipate), poly(hexamethylene adipate), poly(tetramethylene-co-hexamethylene adipate)), succinates (such as poly(butylene succinate), poly-(1,3-propylene succinate)), polycarbonate polyols (such a poly(hexamethylene carbonate), poly(pentamethylene carbonate), poly(trimethylene carbonate)), copolymers of two or more thereof, and mixtures thereof. Component (a) can also be the condensation product of a short (e.g., MW (400-1000 Mn)) polyester glycol and an α-hydroxy acid, such as lactic acid, glycolic acid, or a mixture thereof. Component (a) can also be the condensation product of an α-hydroxy acid, an alkylene diacid (such as one or more of adipic acid, succinic acid, sebacic acid, azelaic acid), and an alkylene diol (such as one or more of ethylene glycol, propylene glycol, butanediol, hexanediol). Component (a) can also be an alpha, omega-hydroxy telechelic random copolymer of at least one of a cyclic lactone, a carbonate, and an ester monomer, such as D-lactide, L-lactide, meso-lactide, glycolide, dioxanone, trimethyl carbonate, acetolactone, propiolactone, butyrolactone, valerolactone, and caprolactone. One particularly suitable polyol includes poly(lactide-co-caprolactone (CAPA) or a derivative thereof.

The mole ratio of cyclic lactone (e.g., caprolactone) to α-hydroxy acid (e.g., lactide) in the copolymer can be about 95:5 to about 30:70, such as from 45:55 to 30:70 or from about 95:5 to about 5:95.

The polyester/polyether polyols can be random, block, segmented, tapered blocks, graft, triblock, etc., having a linear, branched, or star structure.

The weight average molecular weight of component (a) (polyol) within the exemplary polymer can be up to 20,000, and in one embodiment, up to 10,000, such as in the range of 500-5000. A glass transition temperature of component a) can be lower than ambient temperature (e.g., lower than 25° C.) and in one embodiment, lower than 0°, or lower than −15° C.

The chemical composition of component (a) can be chosen so that it is sufficiently different in polarity, has the ability to hydrogen-bond, and other such properties known to those skilled in the art so that it will effectively phase separate from the hard segment of the multi-block copolymer that is formed on reaction of the various components. Lack of phase separation can result in the properties of the final product being compromised, although for some applications, such lack of phase separation may be acceptable or even useful.

Component (b) is generally a low molecular weight diol or diamine chain extender. Suitable chain extenders include diols, diamines, and combinations thereof. Exemplary chain extenders include alkane diols of from 1-30 carbon atoms, ethylene glycol, 1,3-propanediol, 1,2-propanediol, 1,4-butanediol, pentanediol, hexamethylenediol, heptanediol, nonanediol, dodecanediol, 2-ethyl-1,3-hexanediol (EHD), 2,2,4-trimethyl pentane-1,3-diol (TMPD), 1,6-hexanediol, 1,4-cyclohexane dimethanol, diethylene glycol, dipropylene glycol, and combinations thereof. Suitable diamine chain extenders can be aliphatic or aromatic in nature, such as alkylenediamines of from 1-30 carbon atoms (e.g., ethylenediamine, butanediamine, hexamethylenediamine). Component (b) can also be synthesized by condensation of an alpha-hydroxy acid, such as lactic acid, glycolic acid, or a mixture thereof, with a small alkylenediol and/or hydroxyl amine molecule of from 1-20 carbon atoms, such as ethylene glycol, butanediol, hexamethylenediol, ethanolamine, aminobutanol, or a mixture thereof. Component (b) can also be synthesized by condensation of an alpha-amino acid such as glycine, lycine or similar amino acids with a small alkylene diol molecule of from 1-20 carbon atoms such as ethylene glycol, butane diol, hexamethylene diol or a mixture of thereof.

The chain extender can have a number-average molecular weight Mn of up to 2000 and in some embodiments, up to 1000, such as is 100-700.

Component (c) can be a diisocyanate. Suitable isocyanates include aliphatic diisocyanates, such as 4,4′-methylene dicylcohexyl diisocyanate (HMDI), 1,6-hexane diisocyanate (HDI), 1,4-butane diisocyanate (BDI), L-lysine diisocyanate (LDI), 2,4,4-trimethylhexamethylenediisocyanate, other similar diisocyanate, and mixtures thereof. Other diisocyanates which can be used include aromatic diisocyanates such as toluene diisocyanate (TDI), 2,4′-methylene diphenyl diisocyanate, and 4,4′-methylene diphenyl diisocyanate, and mixtures thereof.

Component (c) can be used in an approximately stoichiometrically equivalent amount to the total amount of hydroxyls and amine groups (where present) in the formulation (i.e., in components a) and b)) such that the number of moles of isocyanate groups is equal to the number of moles of hydroxyl and amine groups. This favors high MW TPUs with material properties suited to many biomedical applications. By adjusting this ratio slightly, the molecular weight of the TPU can be controlled to within a desired range. In more embodiments, a molar ratio of isocyanate groups to hydroxyl plus amine groups is in a range of 0.8-1.2. Alternatively or additionally, a monofunctional alcohol, amine, or isocyanate molecule can be utilized in combination with the diisocyanate for controlling the final TPU MW.

Component (d) can be any suitable urethane polymerization catalyst. Some specific examples include metal alkyls, chlorides, esters, and carboxylates, and mixture thereof. Certain amines can also be used as catalysts. In some cases, a catalyst is not needed. For example, it can be dispensed with when the polymerization kinetics are sufficiently fast to produce a high MW TPU in a reasonable amount of time. A weight ratio of catalyst (d) to components (a)+(b)+(c) can be from 0:1 to 0.1:1, e.g., at least 0.0001:1.

Component (e) is also an optional ingredient and can include one or more performance additives such as process aids, antioxidants, UV-stabilizers, light stabilizers, lubricants, mineral and/or inert fillers, colorants, opacifying pigments, and mixtures thereof. A weight ratio of component (e) to components (a)+(b)+(c)+(d) can be from 0:1 to 10:1, e.g., 0.001:1 to 1:1. The hard segment content (% HS) of the copolymer (i.e., the combined content of the components derived from the chain extender and isocyanate, expressed by weight percentage) can range from 2-100 wt. %, 2-95 wt %, and in one embodiment, is at least 5 wt. % or at least 10 wt. %, for at least one of the polymers forming the set of the bioabsorbable polymers. In one embodiment, the set of polymers includes at least one polymer in each of two or more, or at least three, or at least four non-overlapping ranges, such as selected from the following ranges:

i) up 10% HS; ii) 10-15% HS, iii) 15-20% HS, iv) 20-30% HS; v) 30-40% HS; vi) 40-50% HS; vii) 50-60% HS; viii) 60-70% HS; ix) >70% HS, and even x) 100% HS (where the hard segment is based on amino acid based chain extenders, and no soft segment derived from a polyol is present in the TPU). The soft segment content (% SS) of the copolymer (i.e., the percentage by weight of the components derived from the polyol) can range from 5-95%, and in one embodiment, is at least 25% or at least 40%, for at least one of the polymers forming the set of the bioabsorbable polymers. In one embodiment, the set of polymers includes at least one polymer in each of two or more, or at least three, or at least four non-overlapping ranges, such as selected from the following ranges:
i) up 20% SS; ii) 20-30% SS; iii) 30-40% SS; iv) 40-50% SS; v) 50-60% SS; vi) 60-70% SS; vii) 70-80% SS; viii) 80-90% SS; and ix) >90% SS.
The soft segment content can be determined by subtracting the hard segment content from 100%.

The bioabsorbable polymers include at least one bioabsorbable unit. A bioabsorbable unit is one which undergoes hydrolyzation and/or enzymatic cleavage under conditions similar to those which the polymer is expected to be exposed in the body. In general, the polyol includes at least one bioabsorbable unit. In one embodiment, the bioabsorbable unit is derived from an α-hydroxy acid, such as poly lactic acid (PLA) in the soft segment. In other embodiments, at least some of the bioabsorbable units are in the hard segment, e.g., derived from the chain extender.

The bioabsorbable unit content (e.g., α-hydroxy acid content) of the soft segment of the copolymer, expressed as a percentage by weight (% PLA) can range from 2-70 wt. %. In one embodiment, the set of polymers includes at least one polymer in each of two or more, or at least three, or at least four non-overlapping ranges, such as selected from the following ranges:

i) up 5% PLA; ii) 5-10% PLA; iii) 10-15% PLA; iv) 15-20% PLA; v) 20-30% PLA; vi) 30-40% PLA; vii) 40-50% PLA; viii) 50-60% PLA; >60% PLA. The exemplary polymers are useful for a wide variety of biomedical applications. The polymers can be readily tailored to provide selected biodegradation properties and physical and mechanical properties that are suited for a specific application/patient.

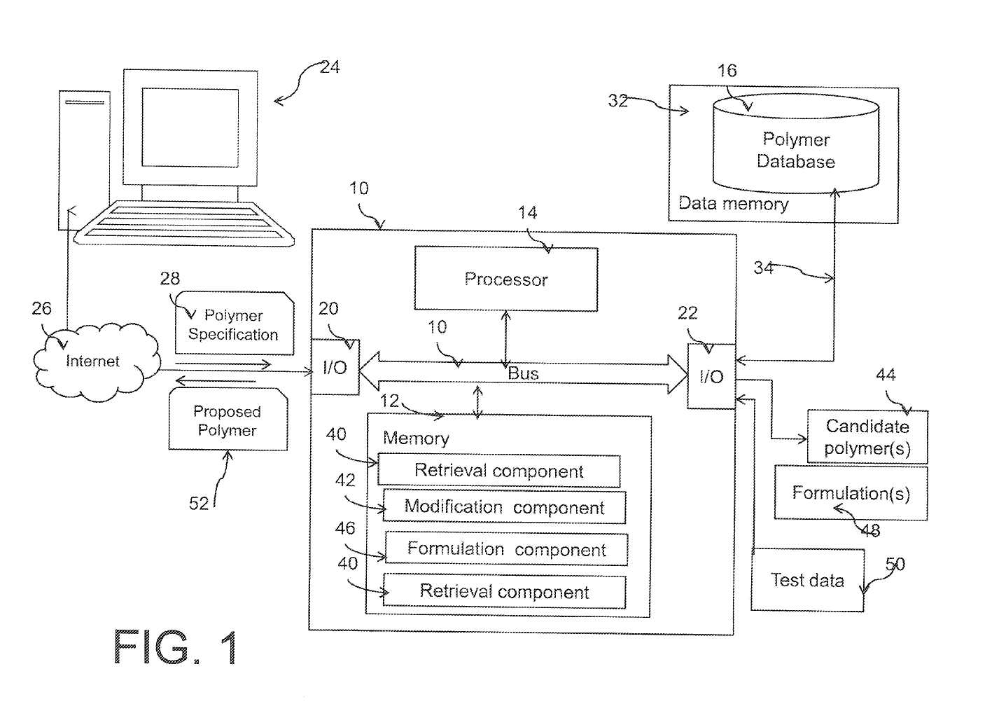

FIG. 1 illustrates an exemplary system for proposing a bioabsorbable thermoplastic polyurethane compound tailored to a medical application in accordance with one aspect of the exemplary embodiment. The system is hosted by one or more computing devices 10, each comprising memory 12 which stores software instructions for performing at least a part of the exemplary method and a processor 14 in communication with the memory which implements the instructions. A data structure 16, which may be stored in memory 12 or in remote memory, stores physical properties and biodegradation properties which have been computed for a set of the bioabsorbable thermoplastic polyurethane compounds covering a range of properties. The data structure may be in the form of one or more tables, graphs, or the like.

The system includes one or more input/output (I/O) devices 20, 22, for communicating with external devices, such as the exemplary client computing device 24. Client computing device 24 may be configured as for computing device 10, except as noted, and may be linked thereto by a wired or wireless link 26, such as a local area network or a wide area network, such as the Internet. The I/O device 20 is configured for receiving, as input, a user input 28 in the form of electronic data, which includes a polymer specification. The polymer specification specifies at least one desired physical property of a thermoplastic polyurethane compound and at least one desired biodegradation property for the thermoplastic polyurethane compound. Hardware components 12, 14, 22, 24 of the system may be communicatively linked by a data/control bus 30. A remote memory storage device 32 which stores the database 16 may be linked to the system by a wired or wireless link 34 to one of the I/O devices 22.

The instructions include a retrieval component 40 which accessing the data structure 16 to identify a base thermoplastic polyurethane compound with a measured physical property and measured degradation rate that are similar to the desired physical property and desired biodegradation property of the input specification 28. The retrieval component 40 may retrieve two or more such base thermoplastic polyurethane compounds, e.g., those which have a measured physical property and a measured degradation rate which are the closest higher and lower values to those specified. Assuming that the measured physical property and measured degradation rate for the stored base thermoplastic polyurethane compound(s) in the database do not match the specification, e.g., are not within a specified acceptable range, then a modification component 42 is called which identifies at least one first parameter(s) of the base thermoplastic polyurethane compound that are modifiable to reduce a difference between the desired physical property and the measured physical property. The modification component also identifies at least one second parameter of the base thermoplastic polyurethane compound which is modifiable to reduce a difference between the desired biodegradation property and the measured biodegradation property. While in some cases, the first and second parameters may be the same, in general, they are different. However, it is often the case that the first parameter also influences biodegradation and the second parameter also influences the physical property.

At least one candidate thermoplastic polyurethane compound based on computed modifications is computed, e.g., by implementing an algorithm which relates modifications to the first and second parameters to the at least one physical property and the degradation rate. For example, the modification component 42 inputs these parameters into an algorithm which applies one or more mathematical functions which describe relationships between the first and second parameters and the physical and biodegradation properties of candidate thermoplastic polyurethane compounds, i.e., thermoplastic polyurethane compounds which are not yet stored in the database, but which can be synthesized by modifying parameters of the base thermoplastic polyurethane compounds. The modification component therefore identifies at least one of these candidate thermoplastic polyurethane compounds 44 based on computed modifications to the first parameter(s), the second parameter(s), or a combination of the first and second parameters. A formulation component 46 accesses a data structure such as a look up table, which provides formulations for candidate thermoplastic polyurethane compounds, based on the parameters output by the modification component 42.

The formulation component 46 outputs a formulation 48 for at least one of the candidate thermoplastic polyurethane compounds. The formulation is output for at least one of the candidate thermoplastic polyurethane compounds and may include, for example, a hard segment content, a polyol selected from a predetermined set of polyols, and/or a bioabsorbable unit content of the polyol, and/or suitable amounts of the components a), b), c), and d). The formulation 48 may include, for example, suitable ones of the components a) to e) listed above (to the extent they are to be used) for forming the candidate thermoplastic polyurethane compounds and their amounts/ratios. For example, each of one or more of a) to e) may include two or more alternative compounds from which the formulation component 46 selects one (or more) and/or its amount. The formulation component may also output processing conditions which may be the same or different from that of the base thermoplastic polyurethane compound. The formulation 48 may also be determined manually or partly manually.

The output formulation 48 may be used to synthesize the candidate polymer 44 and its physical and biodegradation properties are then measured. These values can be input to the system 10 for comparison with the specification, or manually compared to the specification 28. If these properties fall within the acceptable values provided by the client in the specification 28 (or within default ranges computed by the system based on the specification), the candidate polymer becomes the proposed polymer which can be suggested to the client. If these properties do not fall within the acceptable values provided by the client in the specification or computed by the system, the candidate polymer can be treated as the base thermoplastic polyurethane compound and the system repeats the modification computation using the measured physical property and a measured degradation rate of the formulated candidate thermoplastic polyurethane compound(s) to identify one or more new candidate polymers and their formulations.

The computer system 10 may be a PC, such as a desktop, a laptop, palmtop computer, portable digital assistant (PDA), server computer, cellular telephone, tablet computer, pager, combination thereof, or other computing device capable of executing instructions for performing the exemplary method.

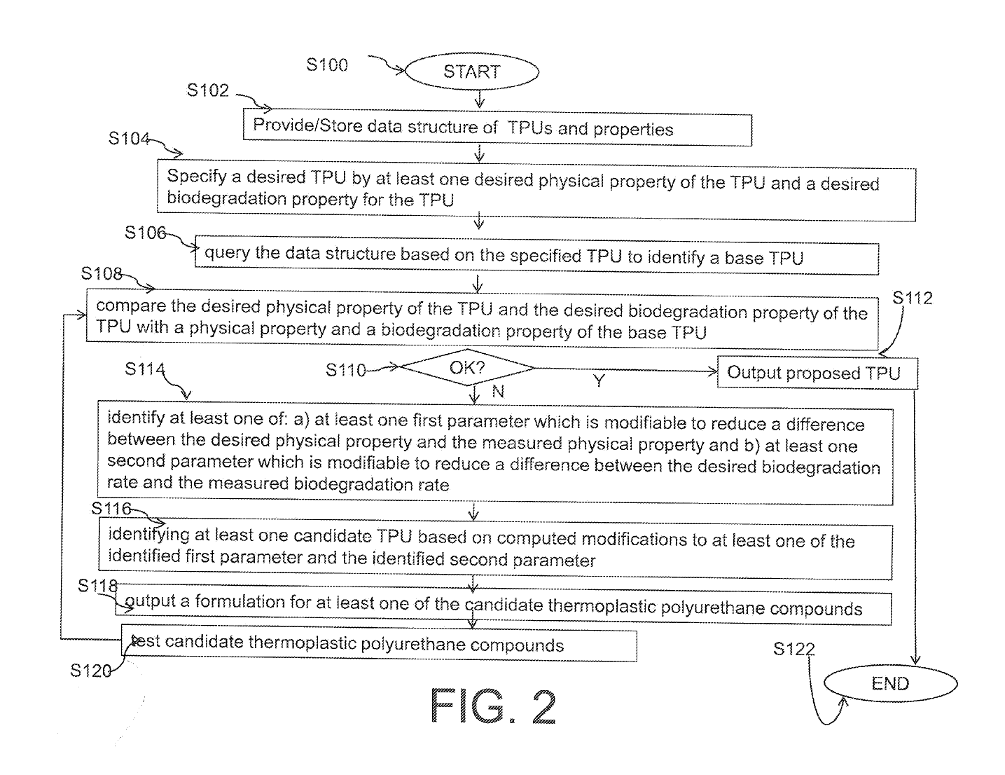

The memory 12, 32 may each represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 14 and memory 12 may be combined in a single chip. The network interface 20, 22 allows the computer to communicate with other devices via a computer network and may comprise a modulator/demodulator (MODEM). Memory 12 stores instructions for performing the exemplary method as well as the processed data 44, 48. The digital processor 14 can be variously embodied, such as by a single-core processor, a dual-core processor (or more generally by a multiple-core processor), a digital processor and cooperating math coprocessor, a digital controller, or the like. The digital processor 14, in addition to controlling the operation of the computer 10, executes instructions stored in memory 12 for performing the method outlined in FIG. 2.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrates the exemplary method for producing a bioabsorbable thermoplastic polyurethane compound tailored to a medical application. The method begins at S100. At S102, a data structure 16 is provided or generated and stored in memory.

At S104, a desired thermoplastic polyurethane compound is specified by at least one desired physical property of the thermoplastic polyurethane compound and a desired biodegradation property for the thermoplastic polyurethane compound.

At S106, the data structure is queried based on the specified thermoplastic polyurethane compound to identify a base thermoplastic polyurethane compound.

At S108, the desired physical property of the thermoplastic polyurethane compound is compared with a physical property of the base thermoplastic polyurethane compound. The desired biodegradation property of the thermoplastic polyurethane compound is compared with a biodegradation property of the base thermoplastic polyurethane compound. At S110, if these are all within specification, the base thermoplastic polyurethane compound is output at S112. Otherwise, the method proceeds to S114, where at least one of the following is identified: a) at least one first parameter which is modifiable to reduce a difference between the desired physical property and the measured physical property, and b) at least one second parameter which is modifiable to reduce a difference between the desired biodegradation rate and the measured biodegradation rate.

Based on these modifiable parameters, at S116, at least one candidate thermoplastic polyurethane compound is identified based on computed modifications to at least one of the identified first parameter and the identified second parameter. At S118, a formulation for at least one of the candidate thermoplastic polyurethane compounds is output.

At S120, the candidate thermoplastic polyurethane compound(s) may be synthesized and the synthesized candidates tested for the physical and degradation properties. The method then returns to S108, where the desired physical property of the thermoplastic polyurethane compound and the desired biodegradation property of the thermoplastic polyurethane compound are compared with the physical property and the biodegradation property of the candidate thermoplastic polyurethane compound(s). At S110, if these properties are now within specification, the method proceeds to S112 and ends at S122. Otherwise, another iteration may be commenced (at S114), where the measured properties are those of the candidate.

The automated steps (S106-S118) of the method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method.

As will be appreciated, the steps of the method need not all proceed in the order illustrated and fewer, more, or different steps.

### Physical Property

The physical property defined in the specification 28 or derived therefrom (for example, by using standard methods of conversion) can be selected from a finite set of physical properties. The system 10 may specify a list of physical properties in a graphical user interface displayed on the client device. By way of example, the selectable physical properties may include one or more of the following: tensile strength, hardness, stiffness (flexibility), resilience, abrasion resistance, impact resistance, coefficient of friction (on the surface of the TPU), creep, modulus of elasticity, thermal transition points (T_{g}, Tₘ), water absorption, moisture permeability and combinations thereof. The graphical user interface may specify a range of each of the selectable physical properties from which the user can select a value. The ranges may be based on the range of physical properties measured for the polymers in the database.

Methods for determining each of these properties and the units in which they can be expressed are given by way of example.

Tensile Strength:

This can be determined according to ASTM F1635-11 Standard Test Method for in vitro Degradation Testing of Hydrolytically Degradable Polymer Resins and Fabricated Forms for Surgical Implants; DOI: 10.1520/F1635-11, which specifies ASTM D638-10 Standard Test Method for Tensile Properties of Plastics, as the method for determining tensile strength. Exemplary polymers have initial tensile strengths, according to this test method, in the range of 5-80 MPa, such as 35-70 MPa. Percentage change in tensile strength can be used as a degradation property, as noted below. The set of polymers in the database may include polymers which vary in their tensile strength by at least 5 MPa, or at least 10 MPa, or at least 20 MPa, or vary by at least 10%, or at least 20%, or at least 30%.

Hardness:

This can be determined according to ASTM D2240-05(2010) Standard Test Method for Rubber Property—Durometer Hardness, DOI: 10.1520/D2240-05R10. Exemplary polymers have a hardness, according to this test method in the range of 60-85 Shore A, e.g., 65-75 Shore A. The set of polymers in the database may include polymers which vary in their hardness by at least 5 Shore A, or at least 10 Shore A, or at least 20 Shore A, or vary by at least 10%, or at least 20%.

Stiffness (Flexibility):

This can be determined according to ASTM D790-10 Standard Test Methods for Flexural Properties of Unreinforced and Reinforced Plastics and Electrical Insulating Materials, DOI: 10.1520/D0790-10. Exemplary polymers have a stiffness, according to this test method, in the range of 5-15000 MPa. The set of polymers in the database may include polymers which vary in their stiffness by at least 5 MPa, or at least 20 MPa, or at least 1000 MPa, or vary by at least 10%, or at least 20%, or at least 30%.

Resilience (Rebound):

This can be determined according to ASTM D2632-01(2008) Standard Test Method for Rubber Property—Resilience by Vertical Rebound, DOI: 10.1520/D2632-01R08. Exemplary polymers have a resilience, according to this test method, in the range of 1-95%, such as 30-80%. The set of polymers in the database may include polymers which vary in their resilience by at least 5%, or at least 10%, or at least 20%.

Abrasion Resistance:

This can be determined according to ASTM D3389-10 Standard Test Method for Coated Fabrics Abrasion Resistance (Rotary Platform Abrader); DOI: 10.1520/D3389-10 (Taber, H18 wheel, 1000 g). Exemplary polymers have an abrasion resistance, according to this test method, in the range of 2-400 mg/1000 cycles, such as 2-100 mg/1000 cycles. The set of polymers in the database may include polymers which vary in their abrasion resistance by at least 5 mg, or at least 10 mg, or at least 20 mg, or vary by at least 10%, or at least 20%, or at least 30%.

Impact Resistance (Izod):

This can be determined according to ASTM D256-10 Standard Test Methods for Determining the Izod Pendulum Impact Resistance of Plastics; DOI: 10.1520/D0256-10. Exemplary polymers have an impact resistance, according to this test method, in the range of No failure—10 ft-lb/in, such as No failure—2 ft-lb/in. Percentage change in impact resistance can be used as a degradation property, as noted below. The set of polymers in the database may include polymers which vary in their tensile strength by at least 1 ft-lb/in or at least 2 ft-lb/in, or vary by at least 10%, or at least 20%.

Coefficient of Friction (on the Surface of the TPU):

This can be determined according to ASTM D1894-11e1 Standard Test Method for Static and Kinetic Coefficients of Friction of Plastic Film and Sheeting, DOI: 10.1520/D1894-11E01. Exemplary polymers have a coefficient of friction, according to this test method, in the range of 0.5-10. The set of polymers in the database may include polymers which vary in their coefficient of friction by at least 0.5, or at least 1.0, or vary by at least 5%, or at least 10%, or at least 20%.

Creep:

This can be determined according to ASTM D2990-09 Standard Test Methods for Tensile, Compressive, and Flexural Creep and Creep-Rupture of Plastics, DOI: 10.1520/D2990-09. Exemplary polymers have creep, according to this test method, in the range of 5-95%, or 50-40%. The set of polymers in the database may include polymers which vary in their creep by at least 5%, or at least 10%, or at least 20%.

Modulus of Elasticity:

This can be determined according to ASTM F1635-11. Exemplary polymers have a modulus of elasticity, according to this test method, in the range of 10-2000 MPa. The set of polymers in the database may include polymers which vary in their modulus of elasticity by at least 10 MPa, or at least 20 MPa, or at least 100 MPa, or vary by at least 5%, or at least 10%, or at least 20%.

Thermal Transition Points: (Gas Transition Temperature, T_{g}, Melting Point Tₘ)

These can be determined according to ASTM D3418-08 Standard Test Method for Transition Temperatures and Enthalpies of Fusion and Crystallization of Polymers by Differential Scanning calorimetry; DOI: 10.1520/D3418-08. Exemplary polymers have a T_{g}, according to this test method, in the range of −60-50° C., e.g., −60-0° C., and a Tₘ of 80-200° C. The set of polymers in the database may include polymers which vary in their T_{g} or Tₘ by at least 10° C., or at least 20° C., or at least 100° C.

Water Absorption:

This can be determined according to ASTM D570-98(2010)e1 Standard Test Method for Water Absorption of Plastics; DOI: 10.1520/D0570-98R10E01. Exemplary polymers have a water absorption, according to this test method, in the range of 0.5-1000%, e.g., 5-600%. The set of polymers in the database may include polymers which vary in their water absorption by at least 10%, or at least 50%, or at least 100%.

Water Vapor Transmission (Moisture Permeability):

This can be determined according to ASTM E96/E96M-10 Standard Test Methods for Water Vapor Transmission of Materials, DOI: 10.1520/E0096_E0096M-10 (Upright cup, 23° C., 50% RH). Exemplary polymers have a moisture permeability, according to this test method, in the range of 0-900 g/m²*24 h. The set of polymers in the database may include polymers which vary in their moisture permeability by at least 10 g/m²*24 h, or at least 100 g/m²*24 h, or at least 500 g/m²*24 h.

Of these properties, tensile strength and hardness are particularly useful.

### First Parameter

Following are examples of first parameters which are modifiable to reduce a difference between the desired physical property and the measured physical property, and suitable methods which can be used to measure them.

The first parameter can be selected from a predefined set of first parameters. These can include one or more of hard segment content of the candidate thermoplastic polyurethane, molecular weight the candidate thermoplastic polyurethane, stoichiometry of the candidate thermoplastic polyurethane; a molecular weight of a polyol-derived component of the candidate thermoplastic polyurethane, a hydrophilicity of a polyol-derived component of the candidate thermoplastic polyurethane, a difference in polarity between the soft segments and the hard segments, a difference in the degree of hydrogen bonding between the soft segments and hard segments, a molecular weight of the soft segment, a polarity of the soft segments, a crystallinity of the soft segments, and combinations thereof.

These can be determined as follows: Hard segment content of the candidate thermoplastic polyurethane: % HS, as described above. This can be adjusted by changing a ratio of polyol to chain extender. The hard segment content is stored for each of the thermoplastic polyurethanes and can be estimated for the candidate thermoplastic polyurethane.

Molecular weight the candidate thermoplastic polyurethane: this can be the weight average molecular weight M_{w} or the number average molecular weight Mₙ. Values for the base thermoplastic polyurethanes are determined and stored in memory, such as memory 16. Values for the candidate thermoplastic polyurethane can be computed by the algorithm. Stoichiometry of the candidate thermoplastic polyurethane. This can be described in terms of a molar ratio of the polyol derived component to the chain extender derived component in the formulation and/or by a molar ratio of isocyanate to hydroxyl groups in the formulation. Values for the candidate thermoplastic polyurethane can be computed by the algorithm.

Molecular weight of a polyol-derived component of the thermoplastic polyurethane: this value may be determined by GPC, according to ASTM F1635-11, or by hydroxyl number determination. Exemplary polymers may have a molecular weight of 80-250 KDa, e.g., 100-200 KDa, e.g., 100-200 KDa Values for the candidate thermoplastic polyurethane can be computed by the algorithm.

A hydrophilicity of a polyol-derived component of the candidate thermoplastic polyurethane. This value may be precomputed for each of the selectable polyols and stored in database 16. Values for the candidate thermoplastic polyurethane can be computed by the algorithm.

A difference in polarity between the soft segments and the hard segments: this value may be precomputed for each of the base thermoplastic polyurethanes and stored in database 16. Values for the candidate thermoplastic polyurethane can be computed by the algorithm. A difference in the degree of hydrogen bonding between the soft segments and hard segments: this value may be precomputed for each of the base thermoplastic polyurethanes and stored in database 16. Values for the candidate thermoplastic polyurethane can be computed by the algorithm.

A molecular weight of the soft segment (Mₙ or M_{w}): Values for the candidate thermoplastic polyurethane can be computed by the algorithm. A polarity of the soft segments: Values for the candidate thermoplastic polyurethane can be computed by the algorithm.

A crystallinity of the soft segments. Values for the candidate thermoplastic polyurethane can be computed by the algorithm.

For example, when the physical property includes tensile strength, the first parameter can include molecular weight of the thermoplastic polyurethane and optionally also hard segment content. As another example, when the physical property includes hardness, the first parameter can include hard segment content. As another example, when the physical property includes stiffness, the first parameter can include the hard segment content % HS and the optionally hydrophilicity of the polyol-derived component of the candidate thermoplastic polyurethane.

### Second Parameter

The degradation rates of the exemplary TPUs depend on a number of factors. First is the number of hydrolysable units in the TPU's backbone. Generally, the higher the number of hydrolysable units in the polymer's backbone, the more rapid is the degradation rate. This, however, is not the only factor that impacts degradation rate. The hydrophilicity of the TPU is also a significant contributor to the degradation rate. For a polymer to hydrolyze it must come into contact with water and if a polymer is very hydrophobic, the rate of resorption will be significantly lower for a given percentage of hydrolysable polymer backbone units when compared with a polymer that is more hydrophilic. This tends to be related to the HS % since the HS is significantly more hydrophobic than the soft segment.

Another factor that impacts the degradation rate is the degree of crystallinity of the polymer. Since the exemplary materials are primarily for use in the body are based on aliphatic isocyanates and this type of TPU does not have crystalline hard segments like aromatic TPUs, the main contributor to crystallinity is the soft segment crystallinity. As the lactic acid content increases, the concentration of hydrolytically labile ester groups increases. Formulations based on amorphous CAPA polyols with higher number of ester linkages for a given hard segment content therefore are expected to degrade faster. Lower lactic acid content based formulations are expected to degrade slower due to crystalline (more hydrophobic) nature and lower number of ester linkages.

Phase mixing, which is related to a number of factors including polyol molecular weight and overall TPU Mw, can also affect the rate of degradation. As the more hydrophobic hard phases are more phase-mixed into the hydrolysable soft segments, the overall hydrophobicity of the soft phase will increase and the degradation rate will, as a result, decrease. In the exemplary embodiment, therefore, the second parameter, affecting biodegradation, can include one or more of a finite set of second parameters, such as one or more of a parameter based on a quantity of bioabsorbable units in a backbone structure of the candidate thermoplastic polyurethane compound, a hydrophobicity of a polyol-derived component of the thermoplastic polyurethane compound, a molecular weight of the polyol-derived component, and combinations thereof.

These can be determined as follows: Parameter based on a quantity (e.g., number average, molar ratio, or the like) of bioabsorbable units in a backbone structure of the candidate thermoplastic polyurethane compound: this can include one or both of a quantity of hydrolysable units and a quantity of enzymatically cleavable units. This can be the % PLA, as described above, i.e., the bioabsorbable units in the soft segment. However, other components (e.g., chain extender) of the backbone of the bioabsorbable polymer may also include bioabsorbable units and these may be included in the overall quantity of bioabsorbable units.

For the candidate thermoplastic polyurethane, this can be computed by the algorithm.

Hydrophobicity of a polyol-derived component of the thermoplastic polyurethane compound: For the candidate thermoplastic polyurethane, this can be computed by the algorithm.

A molecular weight of the polyol-derived component. For the candidate thermoplastic polyurethane, this can be computed by the algorithm.

It will be noted that some of the degradation rate parameters described above are also physical property parameters. In some embodiments, the invention includes the proviso that the one or more degradation rate parameters used is in the process are each different from the one or more physical property parameters used in the process and in some cases more than one parameter must be adjusted to maintain the degradation rate while adjusting one or more physical properties to the desired level, while in other cases more than one parameter must be adjusted to maintain one or more physical properties, while adjusting the degradation rate to the desired level.

### Degradation Property

The degradation property (which may be referred to as the degradation rate) can be expressed as a function of at least one of: a change in molecular weight of the polymer with time, a change in tensile strength of the polymer with time, a change in impact resistance of the polymer with time, and a change in weight of the polymer with time. These values are determined in vitro, in a suitable test environment, such as a liquid, with properties of the TPU being measured at intervals, such as days, weeks, or months. In the exemplary embodiment, these degradation properties are measured according to ASTM 1635-11.

The change in tensile strength (or impact resistance) can be expressed as a percentage of the initial value, where the initial and subsequent values are measured according to ASTM 1635-11, as described above. The set of polymers in the database may include polymers which vary in their % change in tensile strength over eight weeks by at least 20%, or at least 40%, or at least 60%.

Weight loss: The change in weight can be measured according to ASTM 1635-11, expressed as a percentage of the initial value. The set of polymers in the database may include polymers which vary in their change in weight over eight weeks by at least 20%, or at least 40%, or at least 60%.

Molecular Weight loss: The change in molecular weight can be measured according to ASTM 1635-11, expressed as in KDa. The set of polymers in the database may include polymers which vary in their change in molecular weight over eight weeks by at least 20%, or at least 40%, or at least 60%.

In the Examples below, the degradation property is measured according to ASTM F1635-11 (Standard test method for in vitro degradation testing of hydrolytically degradable polymer resins and fabricated forms for surgical implants). This test method is specified for use with polymers that are known to degrade primarily by hydrolysis, such as homopolymers and copolymers of l-lactide, d-lactide, d,l-lactide glycolide, caprolactone, and p-dioxanone. In this test, the samples are placed in a phosphate buffered saline (PBS) solution, where the pH is maintained at 7.4+/−0.2 at 37+/−2° C. After each time period, one sample is taken out and tested for tensile strength, elongation, molecular weight, and weight loss, using the test methods described above.

The degradation property can be computed, based on these measurements, and can be expressed as, for example, a loss in the property over a specified time interval, either from the start of the immersion, or starting at a specified time thereafter. The degradation property can be expressed in other ways, such as, for example, the time to reach a specified loss in the property such as a specified weight loss or specified percentage change in weight (e.g., a 50% weight loss), or the like.

### Example Modifications

The properties of the exemplary TPU's tend to be highly dependent on the polymer's molecular weight (Mw), hard segment content (HS %), polyol chemical identity and the degree of phase separation (PS) of the TPU. The design of the candidate polymer typically takes place by adjusting the factors (HS %, Mw, PS, polyol chemical identity) to achieve a TPU which is expected to have the approximate properties required. In order for a polymer to have a certain HS %, the ratio of polyol to chain extender can be adjusted. This would be a primary factor controlling the stiffness (flex modulus) of the polymer. The Mw of the polymer can be controlled by varying the stoichiometry (ratio of isocyanate to hydroxyl groups). This is a significant factor that controls the tensile strength of the polymer although hardness (HS %), phase separation and various other parameters have an effect on this as well but their effect is of a lesser extent. There are other parameters that impact the properties, which include the chemical identity and molecular weight of the polyol used to for the TPU. The chemical identity determines the hydrophilicity/hydrophobicity balance of the TPU formed (which affects water absorption and moisture permeability of the material) and some of the thermal properties of the polymer along with various other properties such as toughness and abrasion resistance. The balancing of each of these requirements for a given application can often only be an approximation, is there are numerous tradeoffs as one property is maximized others are lowered (see Table 1 below).

TABLE 1

| | Increase | Increase | Increase Polyol | Increase polyol |
|---|---|---|---|---|
| Parameter 1 | HS % | TPU Mw | mol. wt. | hydrophilicity |
| Tensile strength | Increases | Increases | Variable* | Typically |
| | | | | decreases |
| Hardness | Increases | No effect | Variable* | No effect |
| Hydrophobicity | Variable* | Increases | Variable* | Decreases |
| Abrasion | Increases | Increases | Increases | Typically |
| resistance | | | | decreases |
| Flexibility | Decreases | No effect | Slightly | Increases |
| | | | decreases | |
| Resilience | Decreases | Increases | Increases | Decreases |

*Varies depending on the morphology (crystalline vs. amorphous) of the polyol and/or the chemical nature (polarity) of the polyol, and/or on the overall balance of effects caused by the change.

The balancing of each of the parameters which impact degradation to give a TPU with a desired degradation rate is also an approximation, since there are numerous tradeoffs in that many of these parameters affect the degradation rate in opposite directions (see Table 2 below).

TABLE 2

| Parameter 2 | Degradation rate |
|---|---|
| Increase Polyol hydrophobicity | Increases |
| Increase polyol mol. Wt. | Increases |
| Increase TPU Mw | Decreases |
| Increase HS % | Decreases |
| Increased Crystallinity | Decreases |
| Decrease number of hydrolysable | Decreases |
| units in polyol backbone | |

The design of a bioresorbable TPU with a specified degradation rate and set of physical properties can thus involve an iterative process whereby the major controllable parameters which affect the physical properties, such as HS %, Mw, polyol molecular weight and chemical identity, stoichiometry, etc. are selected along with the parameters which affect the degradation rate such as number of hydrolysable units in the backbone and the hydrophilicity of the polyol and the polyol molecular weight are chosen. Some parameters, such as hard segment content, may affect both the degradation rate and one or more physical properties of the bioresorbable TPU, and so in some embodiments a second, or even a third parameter is also adjusted along with the first, in order to arrive at a TPU with the desired combination of properties, that is the desired degradation rate and one or more physical properties.

This initial set of parameters is used to prepare a base TPU which and the properties and degradation rate of this material are measured. Based on the results of these initial measurements, a number of additional candidate TPUs are produced, by varying the parameters in such a way that is designed to produce a material that more closely matches the requirements of the application. For example, to produce a material that has the same physical properties as the initial TPU but with a faster degradation rate, then the next set of materials could be prepared using a polyol that has a higher number of hydrolysable units in its backbone or which has a higher hydrophilic character compared to the first polymer. As noted above there are tradeoffs in such a procedure which are difficult to precisely define in the algorithm.

As an example, when the desired degradation rate in the specification 28 is higher (respectively, lower) than that of the base thermoplastic polyurethane compound, the adjustment by the modification component can include at least one of:

(a) increasing (decreasing) a number of bioabsorbable units in a backbone structure of the base thermoplastic polyurethane compound per unit length of the backbone;

(b) increasing (decreasing) a hydrophilicity of a polyol-derived component of the candidate thermoplastic polyurethane compound;

(c) increasing (decreasing) a molecular weight of the polyol-derived component;

(d) decreasing (increasing) a molecular weight of the candidate thermoplastic polyurethane compound;

(e) decreasing (increasing) a hard segment content of the candidate thermoplastic polyurethane compound; and

(f) decreasing (increasing) a crystallinity of the candidate thermoplastic polyurethane compound.

As another example, when the desired physical property in the specification 28 includes a tensile strength property, and the base thermoplastic polyurethane compound has a lower (respectively, higher) tensile strength than the desired tensile strength, the computing of the at least one candidate thermoplastic polyurethane compound includes at least one of:

(a) increasing (decreasing) a hard segment content of the base thermoplastic polyurethane compound by altering a ratio of a polyol to a chain extender in the formulation;

(b) increasing (decreasing) a molecular weight of the base thermoplastic polyurethane compound by varying a stoichiometric ratio of isocyanate to an amount of hydroxyl groups in the thermoplastic polyurethane compound;

(c) increasing (decreasing) the crystallinity of a polyol-derived component; and

(d) increasing a difference in polarity between hard segment components (isocyanate and chain extender) and soft segment components (polyol) of the polymer.

### Hypothetical Example

TPU 1 has tensile strength of X, hardness of Y, and biodegradation rate of Z.

If the customer seeks TPU 2 with the following:

Hardness: >Y

Tensile strength: =X

Biodegradation rate: <Z

The method may include:

1. Increasing the hard segment of TPU to increase the hardness, and/or

2. Decreasing the MW of the soft segment to compensate the tensile strength increase with increasing the hard segment.

3. Increasing the hydrolysable units in the soft segment to increase the degradation rate.

OR

4. Increasing the hard segment content and incorporating hydrolysable units in the hard segment and change the soft segment MW to keep the tensile strength the same.

### Forming the Bioabsorbable Thermoplastic Polyurethane Compound

Any suitable methods can be used for forming the exemplary bioabsorbable copolymers. The exemplary polyols, such as CAPA, are solids at room temperature and may be liquefied by heating prior to blending with the hard segment components. The polyol may be analyzed for hydroxyl number, acid number, and moisture content, and this information stored. By way of example only, a blend can be prepared by premixing the polyol(s) and chain extender(s) or by adding these directly to a reaction vessel. This blend can be heated to a suitable reaction temperature prior to combining with the isocyanate, with stirring, followed by addition of catalyst, if any. The temperature of the reaction can be monitored. Prior to setting or gelling, the polymer can be placed in a suitably shaped mold and cured for a suitable time at a curing temperature of, for example, 100-200° C.

Physical and degradation properties of the cured bioabsorbable polymer are then measured and parameters are obtained.

CAPA polyols can be made by ring opening copolymerization of lactide and caprolactone monomers. This results in a random distribution of lactide-derived units and caprolactone-derived units in the polyol, which can be verified by NMR.

The exemplary method provides the ability to independently and continuously adjust both the degradation rate and the physical properties based on an understanding of the way that the TPU physical properties and degradation rates interact with each other. These relationships include, among others, a relationship between the Mₙ of the polyol in the TPU and amount of phase separation and therefore physical properties, such as rebound. At the same time, however, there is a relationship between properties that affect the degradation rate, like hydrophobicity/hydrophilicity balance in the TPU. Another such relationship is the relationship between hardness and the hydrophilicity/hydrophobicity balance of the TPU. The hydrophobicity/hydrophilicity balance is one of the key properties affecting degradation rate and hardness is one of the key properties affecting the physical and mechanical properties. Therefore, an understanding of the detailed relationship between these factors is beneficial to the design of the TPU and reduces time-consuming trial and error. These relationships enable design of TPUs which can have any combination of physical properties and degradation rate. As a result, time consuming and costly synthesis work is minimized.

Although many different bioresorbable polymers with varying properties and degradation rates are currently commercially available, there are large gaps in properties between the commercially available materials and the degradation rate for a given material can typically not be changed without selecting a different material. The materials of disclosed herein, which offer continuously variable properties and degradation rates, make this limitation no longer a factor. Also, the ability to change the degradation rate for a material with a given set of physical properties or to change the physical properties of a material with given degradation rate by minor changes in the composition/formulation of a single class of materials has not been achievable with the materials currently available. The ability to do this sort of tailoring of properties and degradation rates to precisely match the requirements of a given application will allow the medical device producer to use a polymer which possesses exactly the combination of characteristics (degradation rate, physical properties) which are optimal for their needs. As a result of this unique combination of properties and characteristics, the materials disclosed herein can find extensive use in numerous medical applications.

The method makes use of the versatile polyurethane chemistry to prepare polymers with wide ranges of physical properties. The biodegradation rates of these materials can be varied by adding to the polymeric structure units which can be readily hydrolyzed. The number of hydrolysable units in the TPU backbone per unit length is a useful parameter that can be used to control the degradation rate of the exemplary TPU materials. While degradation mechanisms have been studied previously, the ability to independently and continuously vary both the physical properties and the degradation rates has not been demonstrated. Since TPUs have been used in implanted medical devices for many years without and significant safety issues, the exemplary materials combine the excellent toxicological aspects of the component materials used in the polymer synthesis with the opportunity to provide tailorable properties and degradation rates.

### Examples

Poly(lactide-co-caprolactone)polyols (CAPA polyols) with varying monomer ratios were converted to TPU using 4,4′-methylene dicyclohexyl diisocyanate-1,4-butanediol as the hard segment at 30-60 wt. % hard segment concentrations. The CAPA polyols used include materials such as Perstorp's Capa™ 600422, consisting of a 2 k molecular weight polyol with a composition of 88 caprolactone:12 lactide, on a molar basis. The initial synthesis, characterization and 8 week in vitro bioabsorption data is reported for exemplary bioabsorbable TPUs. The data provides initial results which indicate that independently controlling the physical and biodegradation properties with these materials is readily achievable.

### Materials

Biodegradable copolymers (CAPA polyols) (Mn-2000) composed of caprolactone and lactic acid units at varying ratios were used. These were random polymers, as verified by NMR. However, no stereocenter dyad analysis was made. CAPA polyols with 12.5 and 25.0% lactide are crystalline and those with 30.0 and 50.0% lactide contents are amorphous. HMDI, butanediol, and an aliphatic diisocyanate (Desmodur W) are used as well. Cotin 430 was employed as the reaction catalyst at 100 ppm.

### Synthesis

The TPU's were synthesized using typical aliphatic TPU lab polymerization procedures as follows:

Most polyols are solids at room temperature and so are first liquefied in an oven. Polyols were thoroughly melted and vigorously shaken, prior to blending. If the polyol had not yet been analyzed, a 4 ounce sample of it was submitted for hydroxyl number, acid number, and moisture content. Blends were prepared by premixing the ingredients (polyol(s) and chain extender(s)) in an appropriately sized glass jar or by weighing the ingredients directly into a reactor can. If premixing was used, then all of the blend ingredients were weighed into a glass jar, the lid was tightened, and the contents were vigorously shaken to homogenize the blend. The required amount of polyol blend was poured into the reactor tin can (the reaction can). If weighing directly into a reactor can is the preferred procedure, then all of the blend ingredients were weighed into an appropriately sized reactor cans (a quart size tin can for 400-gram). The blend was placed in the oven to equilibrate at the temperature required for the reaction. The curing pans (Teflon® coated) were preheated to the temperature required for aging. The amount of aliphatic diisocyanate (Desmodur W™) plus an estimated amount of drain residue was weighed into an appropriately sized can, and it was placed in the oven to equilibrate at the temperature required.

As soon as the starting temperature(s) were reached, the reactor cans were removed from the oven(s) and place in the fume hood. A firmly mounted, air driven agitator was positioned approximately ¼inch from the bottom of the reactor can. With slow stirring to avoid splashing, the appropriate amount of diisocyanate was rapidly poured into the reaction can containing the polyol blend. A short time was allowed for the diisocyanate to drain out of the can. The catalyst was added and the start temperature was recorded. The exotherm temperature was monitored every 30 to 60 seconds. Before final product began to set up or gel, the preheated Teflon® coated pan were taken from the oven, the mixer was stopped and the reaction product was poured into the preheated pan. The reaction product temperature was monitored every 30 to 60 seconds until product began to set up or gel. The product was then placed in the oven at 125° C. for 5 hours. After the polymer had cured, the covered pan was removed from the oven and placed in the fume hood to cool.

### Characterization:

The biodegradation test for all samples is performed using the ASTM F1635 (Standard test method for in vitro degradation testing of hydrolytically degradable polymer resins and fabricated forms for surgical implants), as described above. After each time period (here 2 days, 1 week, 2, 4, 8, 12, 20, 28, 36 . . . weeks) one sample is taken out and tested for tensile strength, elongation, molecular weight and weight loss. Only 8 weeks data (molecular weight, tensile and elongation data) for the samples based on CAPA polyols is reported here. Thermal characterization of these materials using DSC is also reported.

Physical properties are measured according to the methods described above.

The DSC curves (not reported here) exhibit endotherms right after the low temperature Tg which is usually attributed to enthalpic relaxation due to left over stress in these polymers. While not wishing to be bound by theory, this is somewhat expected with these materials because the thermodynamic incompatibility of the CAPA polyols and the non-crystalline hard segment is reduced by incorporation of lactic acid units which may decrease the degree of phase separation and phase separation kinetics in these materials. This trend can also be deduced from the increase of the soft or mixed segment glass transition temperature as the lactic acid content is increased. Broad transitions (over 50° C.) are observed for these materials and this range increased as the hard segment content is increased. This is also another manifestation of poor phase separation or high degree of phase mixing present in these materials. This amorphous morphology generated high modulus materials, however a very slight hint of yielding is observed for the high hard segment (60%) formulations. Melting endotherms are observed for the 30 and 45% hard segment formulations probably due to disruption of an ordered non-crystalline segments which do not crystallize or pack rapidly at least not in the time frame of the DSC measurements so no melting transitions during the second heat or crystallization exotherms during the cooling cycles are observed.

### Results

CAPA polyols are classified by the lactic acid contents. The general chemical structure for the TPUs based on these materials is shown below in Structure 1. A number of different polymers were prepared. The polymers synthesized and their thermal characterization (by DSC) are shown in Tables 2, 3, and 4. The results are categorized according to the amount of hard segment; 30, 45, 60%. Control formulations based on PCL (2000 Mn) at 30 and 60% hard segment are also made and being tested. The thermal and biodegradation results for each set of materials are given in Tables. Not all the samples were tested for “hardness” so this property is reported whenever it is available, otherwise it is left blank. PLA content (%) is the polylactide content of the CAPA polyol used in the formulation.

Table 3 shows the PLA content (%) of various CAPA polyols used in the Examples. The CAPAs are identified by the (approximate) PLA content.

TABLE 3
CAPA polyol IDs and PLA contents

| Polyol ID | PLA Content (%) |
|---|---|
| CAPA 12 | 12.5 |
| CAPA 25 | 25.0 |
| CAPA 30 | 30.0 |
| CAPA 50 | 50.0 |

The polymers produced in this study and their initial analysis is shown in Table 4 below. The TPU IDs reference the approximate amounts of polyol PLA wt. % (first number) and hard segment wt. % (second number) in the TPU. A12-30 thus corresponds to a TPU formed from CAPA 12 with a polylactic acid content of the soft segment of 12.5% and a hard segment content of 30%.

TABLE 4
Polymer formulations and thermal properties for materials with
30-60% hard segment content

| | | | Tg (C., | Tg (° C., | | |
|---|---|---|---|---|---|---|
| | Polyol | Hard | 1st | 2nd | Tm (° C., | Hardness |
| TPU ID | PLA % | Seg. % | Heat) | Heat) | 1st Heat) | A |
| A0-30 | 0 | 30 | −47.1 | −42.1 | 67.6 | |
| A0-60 | 0 | 60 | −10.1 | 15.9 | 169.9 | |
| A12-30 | 12.5 | 30 | −37.2 | −30.7 | 71.8 | |
| A12-45 | 12.5 | 45 | −30.4 | −11.1 | 65.1 | |
| A12-60 | 12.5 | 60 | −8 | 29.4 | none | |
| A25-30 | 25 | 30 | −26.9 | −20.9 | 67.5 | |
| A25-45 | 25 | 45 | −23.9 | −5.6 | 59.6/122 | |
| A25-60 | 25 | 60 | −4.7 | 20.1 | none | |
| A30-30 | 30 | 30 | −17.9 | −14.4 | 64.6 | 70 |
| A30-45 | 30 | 45 | −11.9 | −0.3 | 54.8 | 80 |
| A30-60 | 30 | 60 | −5.2 | 25.4 | none | 99 |
| A50-30 | 50 | 30 | 1.1 | 4.1 | 58.7/163.5 | 96 |
| A50-45 | 50 | 45 | −15.8 | −14.1 | 134.7 | |
| A50-60 | 50 | 60 | 14.5 | 36.4 | none | 98 |

The degradation of TPUs was measured and the Mw and tensile strength was plotted as a function of the in vitro degradation time for each series of TPUs. Results for a typical series of polymers are shown below in Table 5. The results indicate that the degradation rate of the polymer is a function of the concentration of biodegradable units in the TPU backbone.

TABLE 5
Degradation of TPUs

| | Time | Tensile | Elongation | Mw | Mn |
|---|---|---|---|---|---|
| TPU ID | Weeks | Str. (MPa) | (%) | (kDa) | (kDa) |
| A0-30 | 0 | 30.6 | 710 | 172.2 | 64.8 |
| | 1 | 25.5 | 909 | 170.6 | 80 |
| | 2 | 24.5 | 699 | 161.1 | 74.1 |
| | 4 | 26.3 | 737 | 152.2 | 72.4 |
| | 8 | 24.6 | 712 | 144.6 | 62.6 |
| A0-60 | 0 | 55.5 | 393 | 145.1 | 76.5 |
| | 1 | 44.6 | 392 | 163 | 77 |
| | 2 | 44.4 | 389 | 152.1 | 73.7 |
| | 4 | 41.6 | 370 | 148.6 | 69.1 |
| | 8 | 43.5 | 374 | 145.2 | 62.9 |
| A12-30 | 0 | 14 | 701 | 199.9 | 92.1 |
| | 1 | 16.5 | 703 | 201.6 | 92 |
| | 2 | 16.3 | 681 | 172.7 | 71.9 |
| | 4 | 16 | 698 | 158.1 | 82.4 |
| | 8 | 15 | 718 | 120 | 55.2 |
| A12-45 | 0 | 33.4 | 550 | 179.2 | 94.2 |
| | 1 | 37.4 | 560 | 184.2 | 86.1 |
| | 2 | 35.1 | 559 | 186.9 | 87.2 |
| | 4 | 32.9 | 530 | 156.4 | 59.6 |
| | 8 | 32 | 549 | 126.8 | 57.7 |
| A12-60 | 0 | 42.2 | 376 | 142 | 63.6 |
| | 1 | 40.2 | 353 | 150 | 72.4 |
| | 2 | 41.5 | 352 | 139.2 | 64.9 |
| | 4 | 39.7 | 340 | 134.4 | 54.9 |
| | 8 | 41.3 | 350 | 120.8 | 53.7 |
| A25-30 | 0 | 9.4 | 593 | 107.2 | 50.3 |
| | 1 | 11.2 | 675 | 109.2 | 54.4 |
| | 2 | 11.9 | 704 | 93.9 | 42.4 |
| | 4 | 11.2 | 703 | 87.4 | 46.9 |
| | 8 | 7.4 | 739 | 66.5 | 32.1 |
| A25-45 | 0 | 27.2 | 544 | 87.3 | 44.5 |
| | 1 | 27.9 | 543 | 86 | 43.5 |
| | 2 | 26.6 | 524 | 77.1 | 39.5 |
| | 4 | 25.8 | 509 | 71.2 | 31.4 |
| | 8 | 23.1 | 521 | 61.2 | 21.7 |
| A25-60 | 0 | 41.4 | 349 | 127.6 | 63.5 |
| | 1 | 40.6 | 318 | 130.9 | 62.7 |
| | 2 | 39.7 | 314 | 138.6 | 68.9 |
| | 4 | 38.6 | 327 | 128.9 | 59.1 |
| | 8 | 39.4 | 323 | 107.1 | 52.2 |
| A30-30 | 0 | 17 | 649 | 181.5 | 66.3 |
| | 1 | 15.4 | 675 | 185.9 | 72.6 |
| | 2 | 15.2 | 671 | 165.6 | 70.8 |
| | 4 | 13.9 | 677 | 125.3 | 59.2 |
| | 8 | 9.7 | 685 | 74.5 | 35.3 |
| A30-45 | 0 | 39.4 | 488 | 141 | 63.7 |
| | 1 | 34.3 | 511 | 146.4 | 63.4 |
| | 2 | 31.9 | 486 | 139.6 | 68.9 |
| | 4 | 31.9 | 391 | 116 | 56.7 |
| | 8 | 29.9 | 508 | 84 | 40 |
| A30-60 | 0 | 53.3 | 340 | 98 | 52 |
| | 1 | 38.5 | 322 | 101.5 | 51.7 |
| | 2 | 39.7 | 325 | 99.2 | 50.7 |
| | 4 | 36.3 | 309 | 93 | 46.9 |
| | 8 | 38.1 | 314 | 81.4 | 40 |
| A50-30 | 0 | 27.5 | 576 | 124.9 | 57 |
| | 1 | 14.5 | 551 | 115.1 | 55 |
| | 2 | 14.2 | 559 | 103 | 50.9 |
| | 4 | 13.2 | 573 | 75.6 | 36.8 |
| | 8 | 7.4 | 522 | 39.8 | 18.1 |
| A50-45 | 0 | 37.2 | 371 | 121.8 | 60.2 |
| | 1 | 29.6 | 363 | 138.5 | 70.3 |
| | 2 | 29.1 | 345 | 125 | 61.8 |
| | 4 | 30.3 | 363 | 95.1 | 46.5 |
| | 8 | 26.6 | 368 | 59.1 | 29 |
| A50-60 | 0 | 43.9 | 249 | 92.3 | 52.1 |
| | 1 | 37.1 | 251 | 126.1 | 60.8 |
| | 2 | 35.2 | 263 | 124.4 | 60.5 |
| | 4 | 37.9 | 245 | 110.6 | 53.5 |
| | 8 | 37 | 241 | 88.5 | 42.7 |

TABLE 6 show physical and biodegradation data for the A30-60 and A50-45 samples to demonstrate that similar biodegradation profiles can be achieved with very different initial tensile strength values.

TABLE 6

| | A30-60 | A50-45 |
|---|---|---|
| Polyol PLA % | 30 | 50 |
| Hard Seg % | 60 | 45 |
| Hardness | 99A | not tested |
| Tensile Str. (Mpa) | 53.3 | 37.2 |
| Elongation % | 340 | 371 |
| % Degrad.-8 wks | 28.5 | 28.5 |

TABLE 7 shows physical and biodegradation data for the samples A50-30 and A25-45 to demonstrate that different biodegradation profiles with the same initial tensile strength values:

TABLE 7

| | A50-30 | A25-45 |
|---|---|---|
| Polyol PLA % | 50 | 25 |
| Hard Seg % | 30 | 45 |
| Hardness | 96A | not tested |
| Tensile Str. (Mpa) | 27.5 | 27.2 |
| Elongation % | 576 | 544 |
| % Degrad.-8 wks | 73.1 | 15.1 |

The data demonstrate that it is feasible to independently vary the degradation rates and tensile properties even with a relatively small data set. 8 weeks degradation rates for the A30-60 and A50-45 samples (28.5% degradation at 8 weeks) are pretty similar, however, the initial mechanical properties for these samples are rather different (53.3 vs. 37.2 MPa). Similarly, samples A50-30 and A25-45 have almost the same initial tensile strengths (27.5 and 27.2 MPa) but the 8 weeks degradation profiles are quite different (73.1% vs. 15.1% degradation).

It was also observed that for the 45% and 60% hard segment samples, the 1 week and 2 weeks GPC M_{w} values are greater than the original M_{w} values. The GPC experiments are all made in the same way using the same solvent (NMP) and no high molecular weight shoulders are observed in the elution graphs (not reported here). In addition, the same drying procedure is used for every sample suggesting this observation is not due to the analysis procedure. This observation may be due to two mechanisms. (1) The left over or generated NCO groups in water may have reacted with the existing urethane, or more likely with the amine groups that are formed by the hydrolysis of the isocyanate. In fact, the observation that this effect becomes more pronounced with increasing hard segment or diisocyanate concentration supports this inference. It may be that with longer reaction time for the polymerization reaction to reach completion or more carefully matching the molar ratio of diisocyanate to the reactive groups, this observation can be reduced or eliminated. (2) The leaching of low molecular weight polymers or oligomers in the buffer solution. The concurrent drop in the polydispersity index and/or absence of a significant broadening of the polydispersity for these samples are in support of this mechanism.

During hydrolytic degradation, the polymer is first hydrated and then breaking of the hydrolytically labile linkages takes place. The hydrophilic/hydrophobic balance of the composition determines the wetting rate and accordingly the degradation rate. The hydrolysis can be catalyzed with acidic and basic moieties or specific enzymes in the body. However, the degradation rates in these Examples are measured in buffered solution where the pH of the medium is maintained close to neutral and no enzymes are present. It is to be expected that the measured degradations rates in vitro may correspond to higher rates in vivo. Accordingly, if the specification provides a desired degradation rate based on in vivo comparisons, this can be reduced to compensate for the difference between in vivo and in vitro results.

While not wishing to be bound by theory, it is noted that both hard and soft segments (ester and urethane linkages) in these samples are prone to hydrolysis. Crystalline segments are less easy to wet and so they are less susceptible to hydrolysis compared to non-crystalline or less ordered amorphous regions. Thus, for compositions using the same polyol, as the hard segment (more ordered or hydrophobic segment) content is increased the degradation rate decreases.

While not wishing to be bound by theory, it is noted that in comparing results for different hardness content TPUs with the same lactic acid content polyol, as the hard segment content of the TPU was increased the degradation rate is generally decreased. This is expected because the number of ester groups in the TPU's backbone are decreased as the hard segment content is increased. They are replaced by urethane linkages which, while still hydrolysable, are considered more resistant to hydrolysis compared to the ester units that are present in a higher concentration in the softer TPUs. In addition, the hard segments of these formulations may be more hydrophobic than the soft segments and as the ratio of the hard segments to soft segments increases, the overall hydrophobicity of the TPU would be expected to increase. The hydrophobicity/hydrophilicity ratio of bioabsorbable polymers is a significant factor in the rate of the bioabsorption. Therefore, on this basis, as well as on the basis of the concentration more easily hydrolyzed ester groups, it can be expected that the TPUs which contain higher percent hard segment would degrade more slowly in the in vitro bioabsorption tests. The degradation data support this expected trend.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements. As used herein, the expression “consisting essentially of” permits the inclusion of substances that do not materially affect the basic and novel characteristics of the composition under consideration. As used herein any member of a genus (or list) may be excluded from the claims.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A system for proposing a bioabsorbable thermoplastic polyurethane compound tailored to a medical application, comprising:
memory which stores a data structure and instructions, the instructions comprising:
(i) receiving a user input specifying:
at least one desired physical property of a thermoplastic polyurethane compound; and
a desired biodegradation property for the thermoplastic polyurethane compound;
(ii) accessing the data structure to identify at least one base thermoplastic polyurethane compound with a measured physical property and measured degradation property that are similar to the desired physical property and desired biodegradation property;
(iii) providing for identifying at least one of:
at least one first parameter which is modifiable to reduce a difference between the desired physical property and the measured physical property, and
at least one second parameter which is modifiable to reduce a difference between the desired biodegradation property and the measured biodegradation property;
(iv) identifying at least one candidate thermoplastic polyurethane compound based on computed modifications to at least one of:
at least one of the at least one first parameter, and
at least one of the at least one second parameter;
(v) outputting a formulation for at least one of the candidate thermoplastic polyurethane compounds;
(vi) optionally, receiving a measured physical property and a measured degradation rate of a formulated one of the at least one of the candidate thermoplastic polyurethane compounds and repeating (iii), (iv), (v) and optionally (vi), wherein the formulated polyurethane compound serves as the base thermoplastic polyurethane compound; and
a processor in communication with the memory which implements the instructions.

2. The system according to claim 1, wherein the at least one physical property is selected from the group consisting of tensile strength, hardness, stiffness (flexibility), resilience, abrasion resistance, impact resistance, coefficient of friction (on the surface of the TPU), creep, modulus of elasticity, thermal transition points (T_{g}, Tₘ), water absorption, moisture permeability and combinations thereof.

3. The system according to claim 2, wherein the at least one physical property includes at least one of tensile strength and hardness.

4. The system according to claim 1, wherein the at least one first parameter includes at least one of the group consisting of:
hard segment content of the candidate thermoplastic polyurethane;
molecular weight the candidate thermoplastic polyurethane,
stoichiometry of the candidate thermoplastic polyurethane;
a molecular weight of a polyol-derived component of the candidate thermoplastic polyurethane;
a hydrophilicity of a polyol-derived component of the candidate thermoplastic polyurethane;
a difference in polarity between the soft segments and the hard segments;
a difference in the degree of hydrogen bonding between the soft segments and hard segments;
a molecular weight of the soft segment;
a polarity of the soft segments, and
a crystallinity of the soft segments.

5. The system according to claim 4, wherein the at least one first parameter includes stoichiometry, which is adjusted by varying at least one of:
a molar ratio of the polyol derived component to the chain extender derived component; and
a molar ratio of isocyanate to hydroxyl groups in the formulation.

6. The system according to claim 1, wherein the at least one physical property includes tensile strength and the at least one first parameter includes molecular weight.

7. The system according to claim 8, wherein the at least one physical property includes tensile strength and the at least one first parameter further includes hard segment content.

8. The system according to claim 1, wherein the at least one physical property includes hardness and the at least one first parameter includes hard segment content.

9. The system according to claim 1, wherein the at least one physical property includes stiffness and the at least one first parameter includes hard segment content and optionally hydrophilicity of a polyol-derived component of the candidate thermoplastic polyurethane.

10. The system according to claim 1, wherein the at least one second parameter includes at least one of the group consisting of:
a parameter based on a quantity of bioabsorbable units in a backbone structure of the candidate thermoplastic polyurethane compound; and
a hydrophobicity of a polyol-derived component of the thermoplastic polyurethane compound; and
a molecular weight of the polyol-derived component.

11. The system according to claim 10, wherein the at least one second parameter includes a parameter based on a quantity of bioabsorbable units in a backbone structure of the candidate thermoplastic polyurethane compound and includes at least one of:
a quantity of hydrolysable units, and
a quantity of enzymatically cleavable units.

12. The system according to claim 11, wherein at least one of the quantity of hydrolysable units and quantity of enzymatically cleavable units includes enzymatically cleavable units derived from at least one of the chain extender and the polyol.

13. The system according to claim 1, wherein when the desired degradation rate is higher than that of the base thermoplastic polyurethane compound, the adjustment includes at least one of:
(a) increasing a number of bioabsorbable units in a backbone structure of the base thermoplastic polyurethane compound per unit length of the backbone;
(b) increasing a hydrophilicity of a polyol-derived component of the candidate thermoplastic polyurethane compound;
(c) increasing a molecular weight of the polyol-derived component;
(d) decreasing a molecular weight of the candidate thermoplastic polyurethane compound;
(e) decreasing a hard segment content of the candidate thermoplastic polyurethane compound; and
(f) decreasing a crystallinity of the candidate thermoplastic polyurethane compound.

14. The system according to claim 1, wherein when the desired degradation rate is lower than that of the base thermoplastic polyurethane compound, the adjustment includes at least one of:
(a) decreasing a number of bioabsorbable units in a backbone structure of the base thermoplastic polyurethane compound per unit length of the backbone;
(b) decreasing a hydrophilicity of a polyol-derived component of the candidate thermoplastic polyurethane compound;
(c) decreasing a molecular weight of the polyol-derived component;
(d) increasing a molecular weight of the candidate thermoplastic polyurethane compound;
(e) increasing a hard segment content of the candidate thermoplastic polyurethane compound; and
(f) increasing a crystallinity of the candidate thermoplastic polyurethane compound.

15. The method according to claim 1, wherein when the desired physical property includes a tensile strength property, and the base thermoplastic polyurethane compound has a lower tensile strength than the desired tensile strength, the computing of the at least one candidate thermoplastic polyurethane compound includes at least one of:
(a) increasing a hard segment content of the base thermoplastic polyurethane compound by altering a ratio of a polyol to a chain extender in the formulation;
(b) increasing a molecular weight of the base thermoplastic polyurethane compound by varying a stoichiometric ratio of isocyanate to an amount of hydroxyl groups in the thermoplastic polyurethane compound;
(c) increasing the crystallinity of a polyol-derived component; and
(d) increasing a difference in polarity between hard segment components and soft segment components of the polymer.

16. The method according to claim 1, wherein when the desired physical property includes a tensile strength property, and the base thermoplastic polyurethane compound has a higher tensile strength than the desired tensile strength, the computing of the at least one candidate thermoplastic polyurethane compound includes at least one of:
(a) decreasing a hard segment content of the base thermoplastic polyurethane compound by altering a ratio of a polyol to a chain extender in the formulation;
(b) decreasing a molecular weight of the base thermoplastic polyurethane compound by varying a stoichiometric ratio of isocyanate to an amount of hydroxyl groups in the thermoplastic polyurethane compound;
(c) decreasing the crystallinity of a polyol-derived component; and
(d) decreasing a difference in polarity between hard segment components and soft segment components of the polymer.

17. The system according to claim 1, wherein the computing at least one candidate thermoplastic polyurethane compound based on computed modifications comprises implementing an algorithm which relates modifications to the first and second parameters to the at least one physical property and the degradation rate.

18. The system according to claim 1, wherein the degradation property is expressed as a function of at least one of:
a change in molecular weight with time;
a change in tensile strength with time;
a change in impact resistance with time; and
a change in weight of the polymer with time.

19. The system according to claim 1, wherein the outputting of the formulation for at least one of the candidate thermoplastic polyurethane compounds comprises outputting:
a hard segment content;
at least one of a polyol selected from a predetermined set of polyols and a bioabsorbable unit content of the polyol.

20. The system according to claim 1, wherein the thermoplastic polyurethane compound is the reaction product of at least one chain extender, an isocyanate, and a polyol.

21. The system according to claim 20, wherein the isocyanate comprises an aliphatic diisocyanate.

22. The system according to claim 21, wherein the isocyanate is selected from the group consisting of 4,4′-methylene dicyclohexyl diisocyanate (HMDI), 1,6-hexane diisocyanate (HDI), 1,4-butane diisocyanate (BDI), L-lysine diisocyanate (LDI), 2,4,4-trimethylhexamethylenediisocyanate, and combinations thereof.

23. The system according to claim 20, wherein the polyol is selected from the group consisting of polyester polyols, polyether polyols, and combinations and derivatives thereof.

24. The system according to claim 23, wherein the polyol is selected from the group consisting of poly lactic acid, polybutylene adipate, polybutylene succinate, poly-1,3-propylene succinate, poly(lactide-co-caprolactone (CAPA), copolymers of two or more thereof, and mixtures thereof.

25. The system according to claim 24, wherein the polyol comprises poly(lactide-co-caprolactone (CAPA) or a derivative thereof.

26. The system according to claim 20, wherein the at least one chain extender is selected from the group consisting of diols, diamines, and combinations thereof.

27. The system according to claim 26, wherein the at least one chain extender is selected from the group consisting of 1,4-butanediol, 2-ethyl-1,3-hexanediol (EHD), 2,2,4-trimethyl pentane-1,3-diol (TMPD), 1,6-hexanediol, 1,4-cyclohexane dimethanol, 1,3-propanediol, diethylene glycol, dipropylene glycol, and combinations thereof.

28. The system according to claim 20, wherein the bioabsorbable unit of the polyol is derived from poly lactic acid.

29. The system according to claim 1, wherein the data structure includes, for each of a set of bioabsorbable thermoplastic polyurethane compounds, a set of physical properties, a biodegradation property, and a set of chemical properties.

30. The system according to claim 29, wherein the chemical properties include at least one of:
a hard segment content of the thermoplastic polyurethane compound; and
a bioabsorbable unit content of a polyol-derived component of the thermoplastic polyurethane compound.

31. The system according to claim 1, wherein the data structure is derived for a set of bioabsorbable thermoplastic polyurethane compounds each having a hard segment content and a bioabsorbable unit content of a polyol-derived component, the data structure covering a range of hard segment contents and a range of bioabsorbable unit contents whereby the data structure includes bioabsorbable thermoplastic polyurethane compounds which differ in their degradation property by a factor of at least 10%, or at least 20%, or at least 50%, or at least 100%, when expressed as time to reach 50% of initial tensile strength when exposed to the same degradation conditions.

32. The system according to claim 31, wherein the factor is at least 200%.

33. The system according to claim 28, wherein the factor is at least 1000%.

34. The system according to claim 1, wherein the data structure includes a biodegradation property for each of a set of bioabsorbable thermoplastic polyurethane compounds that vary by at least one of hard segment content and bioabsorbable unit content of a polyol-derived component.

35. The system according to claim 1, wherein the instructions include instructions for receiving a measured physical property and a measured degradation rate of a formulated one of the at least one of the candidate thermoplastic polyurethane compounds and repeating (iii), (iv), (v) and (vi), wherein the formulated polyurethane compound serves as the base thermoplastic polyurethane compound.

36. The system according to claim 1, further including a graphical user interface, wherein at least one of the receiving of the user input and the outputting of the candidate thermoplastic polyurethane compound is performed with the graphical user interface.

37. A data structure configured for use with the system of claim 1.

38. A method for producing a bioabsorbable thermoplastic polyurethane compound tailored to a medical application, the method comprising:
specifying a desired thermoplastic polyurethane compound by at least one desired physical property of a thermoplastic polyurethane compound and a desired biodegradation property for the thermoplastic polyurethane compound;
with a computer processor, querying a data structure based on the specified thermoplastic polyurethane compound to identify a base thermoplastic polyurethane compound;
comparing the desired physical property of the thermoplastic polyurethane compound and the desired biodegradation property of the thermoplastic polyurethane compound with a physical property and a biodegradation property of the base thermoplastic polyurethane compound;
identifying at least one of:
at least one first parameter which is modifiable to reduce a difference between the desired physical property and the measured physical property;
at least one second parameter which is modifiable to reduce a difference between the desired biodegradation rate and the measured biodegradation rate;
identifying at least one candidate thermoplastic polyurethane compound based on computed modifications to at least one of the identified first parameter and the identified second parameter; and
outputting a formulation for at least one of the candidate thermoplastic polyurethane compounds.

39. The method of claim 38, further comprising:
producing the candidate thermoplastic polyurethane compound and screening the candidate thermoplastic polyurethane compound for the at least one physical property and the biodegradation property;
comparing the desired physical property of the thermoplastic polyurethane compound and the desired biodegradation property of the thermoplastic polyurethane compound with the physical property and the biodegradation property of the candidate thermoplastic polyurethane compound; and
based on the comparison, identifying at least one additional candidate thermoplastic polyurethane compound based on computed modifications to at least one of: the identified first parameter, the identified second parameter, and at least one additional parameter for the base thermoplastic polyurethane compound.

40. A computer program product comprising a non-transitory recording medium storing instructions which, when executed by a computer, perform the method of claim 34.

41. A method for producing a bioabsorbable thermoplastic polyurethane tailored to a medical application, the method comprising:
identifying suitable thermoplastic polyurethane properties based on the medical application, wherein the thermoplastic polyurethane comprises units derived from a diol chain extender, a diisocyanate, and a polyol and the thermoplastic polyurethane properties include a biodegradation rate and at least one physical property; and
identifying a base thermoplastic polyurethane; and
altering at least one parameter of the base thermoplastic polyurethane which relates to the desired thermoplastic polyurethane properties to generate a candidate thermoplastic polyurethane, the altering being performed iteratively until the suitable range of thermoplastic polyurethane properties based on the medical application is met.

42. A formulated set of bioabsorbable thermoplastic polyurethane polymers whose degradation rate and mechanical properties are independently varied over a range and that are each derived from a low molecular weight diol chain extender, a diisocyanate, and a polyol which contains bioabsorbable units in its backbone.

43. The polymers of claim 42, wherein the degradation rate is expressed in terms of a percent decrease at least one physical property over a specified period of time and varies by at least 50%.

44. The polymers of claim 42, wherein the degradation rate is expressed in terms of at least one of:
a percent decrease in tensile strength,
a change in molecular weight with time;
a change in tensile strength with time; and
a change in weight of the polymer with time.

45. The polymers of claim 42, wherein the degradation rate, is expressed in terms of a time to reach a specified reduction in tensile strength.

46. A method for identifying a thermoplastic polyurethane comprising:
defining physical and degradation properties of a class of thermoplastic polyurethanes as a function of a set of parameters selected from the group consisting of molecular weight (Mw), hard segment content (HS %), polyol chemical identity, and the degree of phase separation (PS) of the thermoplastic polyurethane; MW of polyol; contact angle/water absorption (hydrophilicity); and concentration of bioabsorbable units in backbone;
adjusting the parameters to achieve a candidate thermoplastic polyurethane which is expected to have desired physical and degradation properties;
comparing physical and degradation properties of the candidate thermoplastic polyurethane when formulated with the desired physical and degradation properties; and
readjusting the parameters, based on the comparison, to achieve another candidate thermoplastic polyurethane which is expected to have desired physical and degradation properties.
